(19) United States
(12) Patent Application Publication
(10) Pub. No.: US 2016/0202567 A1
(43) Pub. Date: Jul. 14, 2016

(54) LIQUID CRYSTAL DISPLAY DEVICE

(71) Applicant: Samsung Display Co., Ltd., Yongin-Si (KR)

(72) Inventors: Jang Mi KANG, Bucheon-si (KR); Kwang-Chul JUNG, Seongnam-si (KR); Nam Seok ROH, Seongnam-si (KR); Cheol-Gon LEE, Seoul (KR)

(21) Appl. No.: 14/882,281

(22) Filed: Oct. 13, 2015

(30) Foreign Application Priority Data
Jan. 8, 2015 (KR) 10-2015-0002969

(51) Int. Cl. G02F 1/1343

(52) U.S. Cl. CPC G02F 1/134309; G02F 2001/134345

(57) ABSTRACT

A display device may include a first pixel, a second pixel, a first liquid crystal layer, and a second liquid crystal layer. The first pixel may include a first first-pixel subpixel electrode and a second first-pixel subpixel electrode. The second pixel may neighbor the first pixel and may include a first second-pixel subpixel electrode and a second second-pixel subpixel electrode. The first liquid crystal layer may be formed of a first liquid crystal material and may overlap the second first-pixel subpixel electrode. The second liquid crystal layer may be formed of a second liquid crystal material and may overlap the first second-pixel subpixel electrode. A material property of the first liquid crystal material may be different from a material property of the second liquid crystal material.

### CROSS-REFERENCE TO RELATED APPLICATION

This application claims priority to and the benefit of Korean Patent Application No. 10-2015-0002969 filed in the Korean Intellectual Property Office on Jan. 8, 2015; the entire contents of the Korean Patent Application are incorporated herein by reference.

### BACKGROUND

(a) Field

The present invention is related to a liquid crystal display device.

(b) Description of the Related Art

A liquid crystal display device may include two panels with field generating electrodes, such as a pixel electrode and a common electrode, and may include a liquid crystal layer interposed between the two panels. The liquid crystal display device may generate electric fields in the liquid crystal layer by applying a voltage to the electric field generating electrodes to control orientations of liquid crystal molecules of the liquid crystal layer for controlling transmission of incident light, so as to display images. Two substrates may be used for implementing the two panels. The two substrates may undesirably contribute to the thickness, the weight, the manufacturing cost, and/or the manufacturing time of the liquid crystal display device.

The above information disclosed in this Background section is for enhancement of understanding of the background of the invention. The Background section may contain information that does not form the prior art that is already known in this country to a person of ordinary skill in the art.

### SUMMARY

An embodiment of the present invention may be related to a display device that is manufactured by using one substrate. Advantageously, a weight, a thickness, a cost, and/or a manufacturing time associated with the display device may be minimized

Embodiment of the present invention may be related to a display device that can produce three or more gray values using combinations of two voltage levels and two liquid crystal materials. Advantageously, the display device may display images with satisfactory visibility (e.g., satisfactory side visibility).

An embodiment of the present invention may be related to a display device. The display device may include a first pixel, a second pixel, a first liquid crystal layer, and a second liquid crystal layer. The first pixel may include a first first-pixel subpixel electrode and a second first-pixel subpixel electrode. The second pixel may (immediately) neighbor the first pixel and may include a first second-pixel subpixel electrode and a second second-pixel subpixel electrode. The second liquid crystal layer may be formed of a second liquid crystal material and may overlap the first second-pixel subpixel electrode. A material property of the first liquid crystal material may be different from a material property of the second liquid crystal material. These features may be appreciated from, for example, description related to one or more of FIG. 1, FIG. 2, FIG. 6, and FIG. 7 in this application.

A size of the first first-pixel subpixel electrode may be less than a size of the second first-pixel subpixel electrode. A size of the first second-pixel subpixel electrode may be less than a size of the second second-pixel subpixel electrode. A size of the first first-pixel subpixel electrode may be equal to a size of the first second-pixel subpixel electrode. A size of the second first-pixel subpixel electrode may be equal to a size of the second second-pixel subpixel electrode. The first liquid crystal layer may be formed of a first liquid crystal material and may overlap the second first-pixel subpixel electrode. These features may be appreciated from, for example, description related to one or more of FIG. 1, FIG. 2, FIG. 6, and FIG. 7 in this application.

The display device may include a gate line, which may be electrically connected to a gate electrode of the first pixel. The first pixel may be aligned with the second pixel in a direction parallel to an extension direction of the gate line. These features may be appreciated from, for example, description related to one or more of FIG. 1 and FIG. 2 in this application.

The display device may include a third liquid crystal layer and a fourth liquid crystal layer. The third liquid crystal layer may be formed of the first liquid crystal material and may overlap the first first-pixel subpixel electrode. The fourth liquid crystal layer may be formed of the second liquid crystal material and may overlap the second second-pixel subpixel electrode. These features may be appreciated from, for example, description related to one or more of FIG. 1 and FIG. 2 in this application.

The display device may include a third pixel, which may include a first third-pixel subpixel electrode and a second third-pixel subpixel electrode. The first third-pixel subpixel electrode may be smaller than second third-pixel subpixel electrode. The fourth liquid crystal layer may overlap the first third-pixel subpixel electrode. These features may be appreciated from, for example, description related to one or more of FIG. 1 and FIG. 2 in this application.

The display device may include a data line, which may be electrically connected to a source electrode of the second pixel. The second electrode may be aligned with the third pixel in a direction parallel to an extension direction of the data line. These features may be appreciated from, for example, description related to one or more of FIG. 1 and FIG. 2 in this application.

The display device may include a third pixel, which may include a first third-pixel subpixel electrode and a second third-pixel subpixel electrode. The first third-pixel subpixel electrode may be smaller than second third-pixel subpixel electrode. The first liquid crystal layer may overlap the first third-pixel subpixel electrode. These features may be appreciated from, for example, description related to one or more of FIG. 1 and FIG. 2 in this application.

The display device may include a data line, which may be electrically connected to a source electrode of the first pixel. The first pixel may be aligned with the third pixel in a direction parallel to an extension direction of the data line. These features may be appreciated from, for example, description related to one or more of FIG. 1 and FIG. 2 in this application.

The display device may include a third liquid crystal layer, which may be formed of the first liquid crystal material and may overlap the second third-pixel subpixel electrode. These features may be appreciated from, for example, description related to one or more of FIG. 1 and FIG. 2 in this application.

The first liquid crystal layer may overlap a first portion of the second first-pixel subpixel electrode. The second liquid crystal layer may overlap a second portion of the second first-pixel subpixel electrode. These features may be appreciated from, for example, description related to one or more of FIG. 2, FIG. 6, and FIG. 7 in this application.

The display device may include a data line, which may be electrically connected to a source electrode of the first pixel. The first pixel may be aligned with the second pixel in a direction parallel to an extension direction of the data line. These features may be appreciated from, for example, description related to one or more of FIG. 2, FIG. 6, and FIG. 7 in this application.

The display device may include a third liquid crystal layer, which may be formed of the second material and may overlap a first portion of the second second-pixel electrode. These features may be appreciated from, for example, description related to one or more of FIG. 2, FIG. 6, and FIG. 7 in this application.

The display device may include a fourth liquid crystal layer, which may be formed of the first material and may overlap a second portion of the second second-pixel electrode. These features may be appreciated from, for example, description related to one or more of FIG. 2, FIG. 6, and FIG. 7 in this application.

The display device may include a third pixel, which may include a first third-pixel subpixel electrode and a second third-pixel subpixel electrode. The first third-pixel subpixel electrode may be smaller than second third-pixel subpixel electrode. The fourth liquid crystal layer may overlap the first third-pixel subpixel electrode. These features may be appreciated from, for example, description related to one or more of FIG. 2, FIG. 6, and FIG. 7 in this application.

The display device may include a data line, which may be electrically connected to a source electrode of the second pixel. The second pixel may be aligned with the third pixel in a direction parallel to an extension direction of the data line. These features may be appreciated from, for example, description related to one or more of FIG. 2, FIG. 6, and FIG. 7 in this application.

The display device may include a roof layer, which may overlap the first liquid crystal layer and the second liquid crystal layer. A first portion of the roof layer may be positioned between the first liquid crystal layer and the second liquid crystal layer. A second portion of the roof layer may be oblique with respect to the first portion of the roof layer in a plan view of the display device. These features may be appreciated from, for example, description related to one or more of FIG. 2 and FIG. 7 in this application.

The first portion of the roof layer may overlap a stem portion of the second first-pixel subpixel electrode. These features may be appreciated from, for example, description related to one or more of FIG. 2 and FIG. 7 in this application.

The second portion of the roof layer may extend parallel to a branch portion of the second first-pixel subpixel electrode. These features may be appreciated from, for example, description related to one or more of FIG. 2 and FIG. 7 in this application.

The second portion of the roof layer may be positioned between two pixel rows of the display device in a plan view of the display device. These features may be appreciated from, for example, description related to one or more of FIG. 2 and FIG. 7 in this application.

A first area of the display device may correspond to the first first-pixel subpixel electrode and has a first gray value. A second area of the display device may correspond to the second first-pixel subpixel electrode and has a second gray value. A third area of the display device may correspond to the first second-pixel subpixel electrode and has a third gray value. A fourth area of the display device may correspond to the second second-pixel subpixel electrode and has a fourth gray value. The first gray value, the second gray value, the third gray value, and the fourth gray value may be unequal to one another. These features may be appreciated from, for example, description related to one or more of FIG. 1, FIG. 2, FIG. 6, and FIG. 7 in this application.

A dielectric anisotropy of the first liquid crystal material may be different from a dielectric anisotropy of the second liquid crystal material. These features may be appreciated from, for example, description related to one or more of FIG. 1, FIG. 6, and FIG. 7 in this application.

An embodiment of the present invention may be related to a liquid crystal display, which may include the following elements: an insulating substrate; thin film transistors positioned on the insulating substrate, and connected to gate lines and data lines which cross each other while being insulated; a pixel electrode connected to the thin film transistor; a common electrode spaced apart from the pixel electrode with a microcavity interposed between the common electrode and the pixel electrode; a roof layer including an injection hole for exposing one lateral surface of the microcavity; a liquid crystal layer filling the microcavity; and an overcoat configured to cover the injection hole and seal the microcavity, in which the roof layer covers the remaining lateral surfaces except for the one lateral surface of the microcavity, and the liquid crystal layer includes a first liquid crystal material and a second liquid crystal material, and the first liquid crystal material and the second liquid crystal material are respectively positioned in different microcavities.

The first liquid crystal material and the second liquid crystal material may have different properties.

The first liquid crystal material and the second liquid crystal material may have different dielectric anisotropy values.

The plurality of microcavities may include a first microcavity and a second microcavity, and each of the first microcavity and the second microcavity may include a first lateral surface and a second lateral surface which face each other.

The second lateral surface of the first microcavity may be covered by the roof layer, and the first lateral surface of the second microcavity may be covered by the roof layer.

The plurality of first microcavities and the plurality of second microcavities may be alternately positioned in a matrix direction.

The injection hole may expose the first lateral surface of the first microcavity and the second lateral surface of the second microcavity.

The one pixel may include the thin film transistor and the pixel electrode, the one pixel may include a first area and a second area positioned in an extension direction of the data line, the pixel electrode may include a first subpixel electrode positioned in the first area and a second subpixel electrode positioned in the second area, and the first subpixel electrode and the second subpixel electrode may include cross-shaped stem portions including horizontal stem portions and vertical stem portions crossing the horizontal stem portions, respectively, and a fine branch portions obliquely extended from the cross-shaped stem portions.

Each of the first microcavity and the second microcavity may include the second area of one pixel and the first area of another pixel adjacent in the extension direction of the data line.

The first area, in which the first liquid crystal material is positioned, may have a high gray value, and the first area, in which the second liquid crystal material is positioned, may have an intermediate gray value.

The second area, in which the first liquid crystal material is positioned, may have an intermediate gray value, and the second area, in which the second liquid crystal material is positioned, may have a low gray value.

The first microcavity and the second microcavity may be alternately positioned in the extension direction of the data line, and the plurality of first microcavities and the plurality of second microcavities may be disposed in an extension direction of the gate line.

The second area may include a first subarea and a second subarea divided based on the horizontal stem portion.

The first microcavity may include the first subarea, and the second microcavity may include the first area and the second subarea included in adjacent different pixels.

The first microcavity including the first liquid crystal material may have an intermediate gray value, and the first microcavity including the second liquid crystal material may have a low gray value.

The second subarea of the second microcavity including the first liquid crystal material may have an intermediate gray value, the first area of the second microcavity including the first liquid crystal material may have a high gray value, the second subarea of the second microcavity including the second liquid crystal material may have a low gray value, and the first area of the second microcavity including the second liquid crystal material may have the intermediate gray value.

The intermediate gray values of the first microcavity and the second microcavity may be different from each other.

The roof layer may be positioned between the first microcavity and the second microcavity positioned in the second area, and may overlap the horizontal stem portion of the second subpixel electrode.

The roof layer may be positioned between the first microcavity and the second microcavity positioned in the second area, and may be obliquely formed to overlap the fine branch portion.

### BRIEF DESCRIPTION OF THE DRAWINGS

FIG. 1 is a schematic plan view illustrating elements and/or structures in a display device according to an embodiment of the present invention.

FIG. 2 is a plan view illustrating elements and/or structures in one pixel of a display device according to an embodiment of the present invention.

FIG. 3 is a cross-sectional view taken along line III-III indicated in FIG. 1.

FIG. 4 is a cross-sectional view taken along line IV-IV indicated in FIG. 1.

FIG. 5 is a cross-sectional view taken along line V-V indicated in FIG. 1.

FIG. 6 is a schematic plan view illustrating elements and/or structures in a display device according to an embodiment of the present invention.

FIG. 7 is a schematic plan view illustrating elements and/or structures in a display device according to an embodiment of the present invention.

FIG. 8, FIG. 9, FIG. 10, FIG. 11, FIG. 12, FIG. 13, FIG. 14, FIG. 15, FIG. 16, and FIG. 17 are schematic cross-sectional views illustrating elements and/or structures formed in a process of manufacturing a display device according to an embodiment of the present invention.

### DETAILED DESCRIPTION OF EMBODIMENTS

Embodiments of the present invention are described with reference to the accompanying drawings. As those skilled in the art would realize, the described embodiments may be modified in various different ways, all without departing from the spirit or scope of the present invention.

Although the terms “first”, “second”, etc. may be used herein to describe various elements, these elements, should not be limited by these terms. These terms may be used to distinguish one element from another element. Thus, a first element discussed below may be termed a second element without departing from the teachings of the present invention. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

In the drawings, thicknesses of layers, films, panels, regions, etc., may be exaggerated for clarity. Like reference numerals may designate like elements in the specification. When a first element (such as a layer, film, region, or substrate) is referred to as being “on” a second element, the first element can be directly on the second element, or one or more intervening elements may also be present. In contrast, when a first element is referred to as being “directly on” a second element, there are no intended intervening elements between the first element and the second element.

In the description, the term “connect” may mean “electrically connect”; the term “insulate” may mean “electrically insulate”.

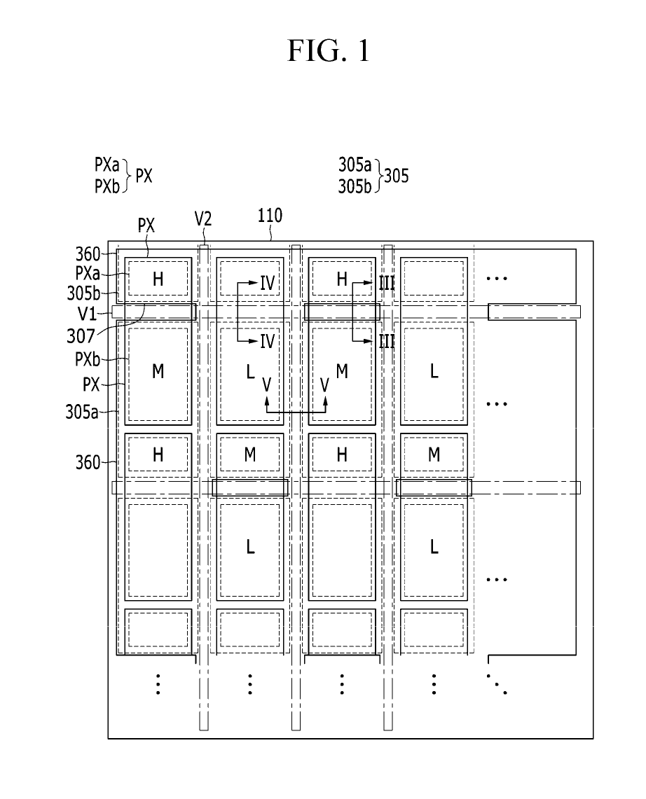

FIG. 1 is a schematic plan view illustrating elements and/or structures in a liquid crystal display according to an embodiment of the present invention.

The display device includes a substrate 110 and a roof layer 360 formed on the substrate 110. The substrate may be made of at least one of glass and plastic.

The substrate 110 includes a plurality of pixels PX. The plurality of pixels PX may form a matrix that includes a plurality of pixel rows and a plurality of pixel columns. Each pixel PX may include one thin film transistor and one pixel electrode. Each pixel PX may include a first-type subpixel area PXa (or first area PXa) in which a first-type subpixel electrode (or first subpixel electrode), a smaller subpixel electrode, is positioned and may include a second-type subpixel area PXb (or second area PXb) in which a second-type subpixel electrode (or second subpixel electrode), a larger subpixel electrode, is positioned. The first area PXa (a smaller area) and the second area PXb (a larger area) may be aligned parallel to an extension direction of a data line and/or may be aligned in a pixel column direction.

A first-type valley V1 (or first valley V1) is positioned between the first area PXa and the second area PXb and may extend parallel to a gate line. A second-type valley V2 (or second valley V2) is positioned between two immediately neighboring pixel columns.

Injection holes 370 may extend through the roof layer 360 (or may be connected to openings of the roof layer 360) and may be positioned along first valleys. V1. The injection holes 307 may enable injection of liquid crystal materials in a process of manufacturing the display device.

Injection holes 307 may be positioned along first valleys V1 and along pixel rows at alternate pixels PX. For example, an injection hole 307 may exist at a first pixel PX in a pixel row, and no injection hole 307 may exist at a second pixel PX in the pixel row, wherein the second pixel PX immediately neighbors the first pixel PX.

Injection holes 307 may be positioned along pixel columns at alternate pixels PX. For example, an injection hole 307 may exist at a first pixel PX in a pixel column, and no injection hole 307 may exist at a second pixel PX in the pixel column, wherein the second pixel PX immediately neighbors the first pixel PX.

In an embodiment, injection holes 307 may be provided at odd-numbered pixels PX of odd-numbered pixel rows and at even-numbered pixels of even-numbered pixel rows, and no injection holes 307 may be provided at even-numbered pixels PX of odd-numbered pixel rows or at odd-numbered pixels of even-numbered pixel rows.

In an embodiment, injection holes 307 may be provided at even-numbered pixels PX of odd-numbered pixel rows and at odd-numbered pixels of even-numbered pixel rows, and no injection holes 307 may be provided at odd-numbered pixels PX of odd-numbered pixel rows or at even-numbered pixels of even-numbered pixel rows.

Microcavities 305 may be provided between the roof layer 360 and the substrate 110 and between immediately neighboring second valleys V2. Each of the microcavities 305 may contain a liquid crystal layer. The microcavities 305 may include first-type microcavities 305a (or first microcavities 305a) and second-type microcavities 305b (or second microcavities 305b). An opening, or injection hole 307, of a first microcavity 305a may face an opening, or injection hole 307, of an immediately neighboring second microcavity 305b.

The roof layer 360 may cover three lateral sides (among the four lateral sides of) of each microcavity 305 and may expose one lateral side of the microcavity 305 through an injection hole 307. The injection hole 307 of a first microcavity 305a positioned at a first side of a first valley V1 may face the injection hole 307 of an immediately neighboring second microcavity 305b positioned at a second side of the first valley V1.

The injection hole 307 of a first microcavity 305a may be positioned at a first lateral side of the first microcavity 305a, which is opposite a second lateral side of the first microcavity 305a. The injection hole 307 of a second microcavity 305b may be positioned at a second lateral side of a second microcavity 305b, which is opposite a first lateral side of the second microcavity 305b and may be opposite a first lateral side of a first microcavity 305a. The second lateral side of the first microcavity 305a is covered by the roof layer 360, and the first lateral side of the second microcavity 305b is covered by the roof layer 360.

In an embodiment, as illustrated in FIG. 1, except for microcavities 305 positioned in the first subpixel row and the last subpixel row, each of a first microcavity 305a and a second microcavity 305b may overlap the second area PXb (and the second subpixel electrode) of a first pixel PX and the first area PXa (and the first subpixel electrode) of a second pixel PX, wherein the second pixel PX immediately neighbors the first pixel PX in a pixel column direction. Each of a microcavity 305a and a second microcavity 305b positioned in the first subpixel row or the last subpixel row may overlap one of a first area PXa and a second area PXb, but not both.

The injection hole 307 of a first microcavity 305a may immediately neighbor or be positioned at the second area PXb associated with the first microcavity 305a (and may be farther from the first area PXa associated with the first microcavity 305a). The injection hole 307 of a second microcavity 305a may immediately neighbor or be positioned at the first area PXa associated with the second microcavity 305b (and may be farther from the second area PXb associated with the second microcavity 305b).

First microcavities 305a and second microcavities 305b may be alternately disposed in a microcavity row direction and in a microcavity column direction. Referring to FIG. 1, in the first microcavity row, which corresponds to the first subpixel row, the microcavities are disposed in a sequence of a second microcavity 305b, a first microcavity 305a, a second microcavity 305b, a first microcavity 305a, etc. In the first microcavity column, which corresponds to the first pixel column, the microcavities are disposed in a sequence of a second microcavity 305b, a first microcavity 305a, a second microcavity 305b, etc.

The microcavities 305 may contain liquid crystal materials having different properties. For example, a first liquid crystal material may be provided through the injection holes 307 positioned in the first valley V1 positioned in the first pixel row, and a second liquid crystal material may be provided through the injection holes 307 positioned in the first valley V1 positioned in the second pixel row.

A material property of the first liquid crystal material may be different from a material property of the second liquid crystal material. In an embodiment, a dielectric anisotropy, a response speed, and/or a transmittance of the first liquid crystal material may be different from a dielectric anisotropy, a response speed, and/or a transmittance of the second liquid crystal material. Accordingly, even if two subpixel electrodes (e.g., positioned in a same pixel row and respectively positioned in two immediately neighboring pixel columns) are driven with the same voltage, luminance of light passing through two subpixels may be different. Advantageously, it is possible to improve visibility of images displayed by the display device.

More particularly, when the first liquid crystal material is injected through the injection holes 307 positioned in the first pixel row (i.e., in first first-type valley V1), the first liquid crystal material is injected only into microcavities 305a and 305b including these injection holes 307, positioned in the odd numbered columns (such as the first column, the third column, and the fifth column), and positioned in the first row.

When the second liquid crystal material is injected into the injection holes 307 positioned in the second pixel row (i.e., in the second first-type valley V1), the second liquid crystal material may be injected only into the microcavities 305a and 305b including these injection holes 307, positioned in the even numbered columns (such as the second column, the fourth column, and the sixth column), and positioned in the second pixel row.

According to an embodiment of the present invention, different liquid crystal materials may be provided for immediately adjacent pixels in different pixel columns, according to positions of the corresponding injection holes.

According to an embodiment of the present invention, a first voltage may be applied to first areas PXa (or first subpixel electrodes), a second voltage may be applied to second areas PXb (or second subpixel electrodes), and the first voltage is larger than the second voltage. In an embodiment, a gray value at each area may be implemented according to the kind of liquid crystal material positioned in the area as well as the voltage applied to the subpixel electrode in the area.

For example, a first area PXa with the first liquid crystal material (which has a relatively high dielectric anisotropy) may exhibit a high gray value. A first area PXa with the second liquid crystal material (which has a relatively low dielectric anisotropy) may exhibit an intermediate gray value. A second area PXb with the first liquid crystal material may exhibit an intermediate gray value. A second area PXb with the second liquid crystal material may exhibit a low gray value.

In an embodiment, the first microcavity 305a positioned in the first microcavity column and in the second microcavity row may receive the first liquid crystal material injected through the associated injection hole 307 positioned in the first pixel row. The second area PXb associated with this first microcavity 305a and receiving the second voltage may exhibit a first intermediate gray value, and the first area PXa associated with this first microcavity 305a and receiving the first voltage may exhibit the high gray value.

In an embodiment, the second microcavity 305b positioned in the second microcavity column and in the second microcavity row may receive the second liquid crystal material injected through the associated injection hole 307 positioned in the second pixel row. The second area PXb associated with this second microcavity 305b and receiving the second voltage may exhibit the low gray value, and the first area PXa associated with this second microcavity 305b and receiving the first voltage may exhibit a second intermediate gray value. Because of the material difference and/or the voltage difference, the second immediate gray value may be unequal to the first immediate gray value.

According to embodiments of the present invention, the liquid crystal display device may apply two different voltages to subpixel electrodes, and three or more different gray values may be implemented in different subpixel areas. Advantageously, with a substantially simple driving operation, the display device may display images with satisfactory visibility.

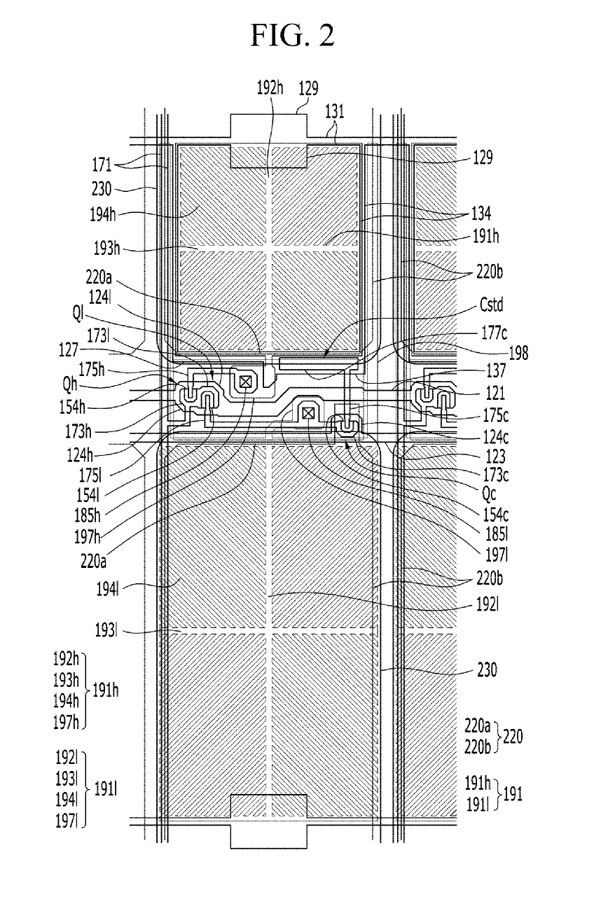

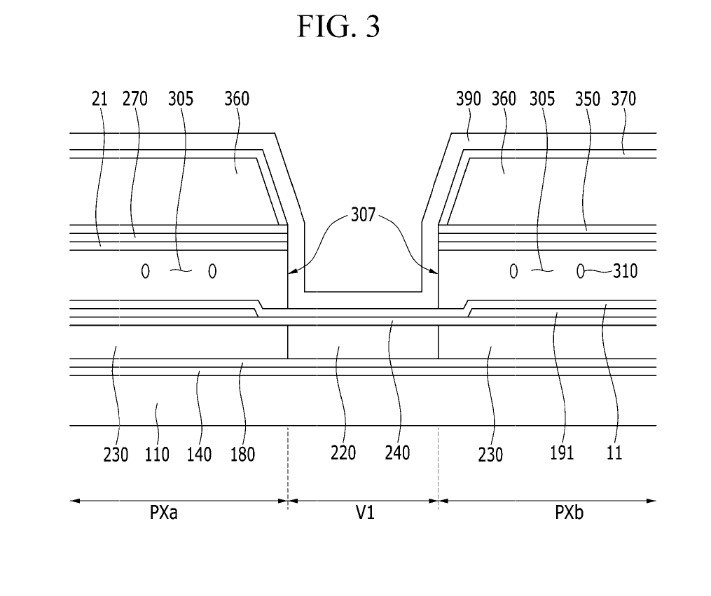

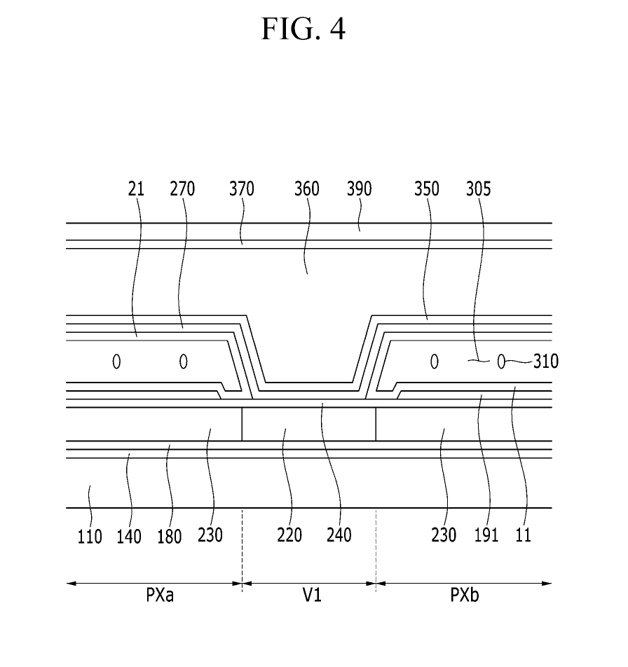

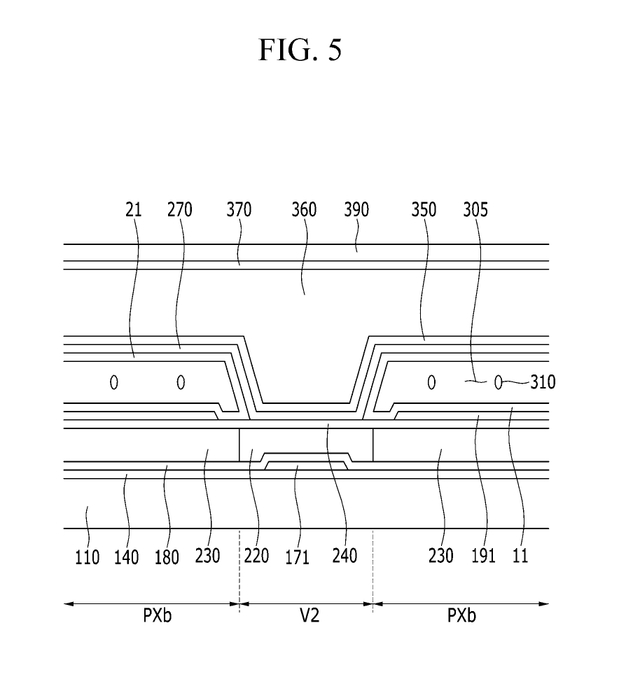

FIG. 2 is a plan view illustrating elements and/or structures in one pixel of the display device according to an embodiment of the present invention. FIG. 3 is a cross-sectional view taken along line III-III indicated in FIG. 1. FIG. 4 is a cross-sectional view taken along line IV-IV indicated in FIG. 1. FIG. 5 is a cross-sectional view taken along line V-V indicated in FIG. 1.

Referring to FIGS. 2 to 5, a pixel of the display device may be associated with a plurality of gate conductors, including a gate line 121, a step-down gate line 123, and a storage electrode line 131, which may be formed on the substrate 110.

The gate line 121 and the step-down gate line 123 may mainly extend in a horizontal direction (or pixel row direction parallel to a first valley V1) and may transfer gate signals. The gate conductors may include a first gate electrode 124h and a second gate electrode 124I that protrude substantially upward and downward, respectively, from the gate line 121. The gate conductors may include a third gate electrode 124c that protrudes upward from the step-down gate line 123. The first gate electrode 124h and the second gate electrode 124I are connected to and substantially aligned with each other in the pixel column direction and may form an enlarged portion of the gate line 121. The gate electrodes 124h, 124l, and 124c may have one or more other protrusion configurations.

The storage electrode line 131 mainly extends in a horizontal direction (e.g., the pixel row direction) and may transfer a predetermined voltage, such as a common voltage Vcom. The storage electrode line 131 includes storage electrodes 129 that protrude upward and downward, a pair of vertical portions 134 that extends toward the gate line 121 and extends substantially vertical to the gate line 121, and a horizontal portion 127 that connects ends of the vertical portions 134. The horizontal portion 127 includes a capacitor electrode 137 that expands toward the gate line 121.

A gate insulating layer 140 is formed on (and may cover) the gate conductors 121, 123, 124h, 124l, 124c, and 131. The gate insulating layer 140 may be made of an inorganic insulating material, such as at least one of silicon nitride (SiNx) and silicon oxide (SiOx). The gate insulating layer 140 may have a single layer structure or a multiple layer structure.

A first semiconductor 154h, a second semiconductor 154l, and a third semiconductor 154c are formed on the gate insulating layer 140. The first semiconductor 154h may be positioned on the first gate electrode 124h, the second semiconductor 154l may be positioned on the second gate electrode 124I, and the third semiconductor 154c may be positioned on the third gate electrode 124c. The first semiconductor 154h and the second semiconductor 154l may be connected to each other, and the second semiconductor 154l and the third semiconductor 154c may be connected to each other. The first semiconductor 154h may be further formed under the data line 171. The semiconductors 154h, 154l, and 154c may be made of one or more of amorphous silicon, polycrystalline silicon, metal oxide, etc.

Ohmic contacts (not illustrated) may be formed on the semiconductors 154h, 154l, and 154c, respectively. The ohmic contacts may be made of silicide or a material (such as n+ hydrogenated amorphous silicon) in which an n-type impurity is doped at high concentration.

The pixel may be associated with a plurality of data conductors, including a data line 171, a first source electrode 173h, a second source electrode 173l, a third source electrode 173c, a first drain electrode 175h, a second drain electrode 175l, and a third drain electrode 175c. Some of the data conductors may be formed on the semiconductors 154h, 154l, and 154c.

The data line 171 may transfer a data signal. The data line 171 may mainly extend in a vertical direction (e.g., the pixel column direction) and may cross the gate line 121 and the step-down gate line 123. The data line 171 may include (or may be connected to) a first source electrode 173h and a second source electrode 173l, which extend toward (and/or correspond to) the first gate electrode 124h and the second gate electrode 124l, respectively, and are connected with each other.

Each of a first drain electrode 175h, a second drain electrode 175l, and a third drain electrode 175c may include a relatively wide portion and a relatively narrow rod-shaped portion. The rod-shaped portions of the first drain electrode 175h and the second drain electrode 175l are partially surrounded by the first source electrode 173h and the second source electrode 173l, respectively. The relatively wide portion of the second drain electrode 175l is connected to a third source electrode 173c, which has a ‘U’-lettered shape. The relatively wide portion 177c of the third drain electrode 175c overlaps the capacitor electrode 137 to form a step-down capacitor Cstd, and the rod-shaped portion of the third drain electrode 175c is partially surrounded by the third source electrode 173c.

The first gate electrode 124h, the first source electrode 173h, and the first drain electrode 175h form a first thin film transistor Qh together with the first semiconductor 154h. The second gate electrode 124l, the second source electrode 173l, and the second drain electrode 175l form a second thin film transistor Ql together with the second semiconductor 154l. The third gate electrode 124c, the third source electrode 173c, and the third drain electrode 175c form a third thin film transistor Qc together with the third semiconductor 154c.

The first semiconductor 154h, the second semiconductor 154l, and the third semiconductor 154c are connected to each other. One or more of the semiconductors 154h, 154l, and 154c may have substantially the same planar shape as one or more of the data conductors 173h, 173l, 173c, 175h, 175l, and 175c and/or one or more of the associated ohmic contacts, except for one or more channel regions between one or more of the source electrodes 173h, 173l, and 173c and one or more of the drain electrodes 175h, 173l, and 175c.

In the first semiconductor 154h, an exposed portion that is not covered by the first source electrode 173h and the first drain electrode 175h is disposed between the first source electrode 173h and the first drain electrode 175h in a plan view of the display device. In the second semiconductor 154l, an exposed portion which is not covered by the second source electrode 173l and the second drain electrode 175l is disposed between the second source electrode 173l and the second drain electrode 175l in a plan view of the display device. In the third semiconductor 154c, an exposed portion that is not covered by the third source electrode 173c and the third drain electrode 175c is disposed between the third source electrode 173c and the third drain electrode 175c.

A passivation layer 180 is formed on the data conductors 171, 173h, 173l, 173c, 175h, 175l, and 175c and portions of the semiconductors 154h, 154l, and 154c exposed between the respective source electrodes 173h, 173l, and 173c and the respective drain electrodes 175h, 175l, and 175c. The passivation layer 180 may be made of an organic insulating material or an inorganic insulating material. The passivation layer 180 may have a single layer structure or a multiple layer structure.

A color filter 230 in each pixel area PX is formed on the passivation layer 180. The color filter 230 may display one of primary colors and/or may display white. In an embodiment, the primary colors may be three primary colors of red, green and blue. In an embodiment, the primary colors may include cyan, magenta, and yellow. In an embodiment, a color filter 230 may extend in a column direction along a space between immediately adjacent data lines 171.

A light blocking member 220 is formed in a region between immediately adjacent color filters 230 and/or between separated portions of color filters. The light blocking member 220 overlaps at least a boundary of the pixel area PX and the thin film transistors to prevent light leakage. A color filter 230 (or a portion of a color filter 230) is formed in each of the first subpixel area PXa and the second subpixel area PXb. A portion of the light blocking member 220 may be formed between the first subpixel area PXa and the second subpixel area PXb to cover the thin film transistors.

The light blocking member 220 includes a horizontal light blocking member 220a that extends along the gate line 121 and the step-down gate line 121 and covers the first thin film transistor Qh, the second thin film transistor Ql, and the third thin film transistor Qc. The light blocking member 220 further includes a vertical light blocking member 220b that extends along the data line 171. The horizontal light blocking member 220a may overlap a first valley V1, and the vertical light blocking member 220b may overlap a second valley V2. The color filter 230 and the light blocking member 220 may directly contact each other in a same layer of the display device and may both directly contact the passivation layer 180.

A first-type insulating layer 240 (or first insulating layer 240, for conciseness) may be formed on the color filter 230 and the light blocking member 220. The first insulating layer 240 may be made of an inorganic insulating material, such as at least one of silicon nitride (SiNx) and silicon oxide (SiOx). The first insulating layer 240 serves to protect the color filter 230 (which may be made of an organic material) and the light blocking member 220. In an embodiment, the first insulating layer 240 may be omitted.

In the first insulating layer 240, the light blocking member 220, and the passivation layer 180, a first contact hole 185h and a second contact hole 185l are formed.

A pixel electrode 191 is formed on the first insulating layer 240. The pixel electrode 191 may be made of a transparent metal material, such as at least one of indium tin oxide (ITO) and indium zinc oxide (IZO). The pixel electrode 191 may be connected to drain electrodes through the contact holes 185h and 185l.

The pixel electrode 191 includes a first-type subpixel electrode 191h (or first subpixel electrode 191h, for conciseness) and a second-type subpixel electrode 191l (or second subpixel electrode 191l), which are separated from each other with the gate line 121 and the step-down gate line 123 being disposed substantially between the subpixel electrodes 191h and 191l. The subpixel electrodes 191h and 191l may be substantially aligned each other in a column direction. The first subpixel electrode 191h and the second subpixel electrode 191l may be separated from each other with the first valley V1 being disposed therebetween in a plan view of the display device. The first subpixel electrode 191h is positioned in the first subpixel area PXa, and the second subpixel electrode 191l is positioned in the second subpixel area PXb.

The first subpixel electrode 191h and the second subpixel electrode 191l are connected to the first drain electrode 175h and the second drain electrode 175l through the first contact hole 185h and the second contact hole 185l, respectively. Accordingly, when the first thin film transistor Qh and the second thin film transistor Ql are turned on, the first subpixel electrode 191h and the second subpixel electrode 191l receive data voltages from the first drain electrode 175h and the second drain electrode 175l.

An overall shape of the first subpixel electrode 191h and the second subpixel electrode 191l may be substantially a quadrangle. The first subpixel electrode 191h and the second subpixel electrode 191l include cross stems. The cross stems include horizontal 193h and 193l and vertical stems 192h and 192l that cross the horizontal stems 193h and 193l, respectively. The first subpixel electrode 191h and the second subpixel electrode 191l may include a plurality of minute branches 194h and 194l and may include protrusions 197h and 1971 protruding downward or upward from edge sides of the subpixel electrodes 194h and 194l, respectively.

Each of the subpixel electrodes 191h and 191l of the pixel electrode 191 is divided into four sub-regions by an associated one of the horizontal stems 193h and 193l and an associated one of the vertical stems 192h and 192l. The minute branches 194h and 194l obliquely extend from the horizontal stems 193h and 193l and the vertical stems 192h and 192l, extending at an angle of approximately 45 degrees or 135 degrees with respect to the gate line 121 or the horizontal stems 193h and 193l. In an embodiment, directions in which the minute branches 194h and 194l of the two adjacent sub-regions extend may be perpendicular to each other.

In an embodiment, the first subpixel electrode 191h may include an outer stem that surrounds at least some elements of the first subpixel electrode 191h. The second subpixel electrode 191l may include horizontal portions positioned at an upper end and a lower end of the second subpixel electrode 191l. The pixel electrode 191 may include left and right vertical portions 198 positioned at the left and the right of the first subpixel electrode 191h. The left and right vertical portions 198 may prevent capacitive coupling between the data line 171 and the first subpixel electrode 191h.

The layout shape of the pixel area, the structure of the thin film transistor, and the shape of the pixel electrode described above are examples and may be modified in various embodiments.

A common electrode 270 may overlap the pixel electrode 191 and may be spaced from the pixel electrode 191 at a predetermined distance. A microcavity 305 is formed between the pixel electrode 191 and the common electrode 270. The microcavity 305 may be substantially surrounded by at least one of the pixel electrode 191 and the common electrode 270. A width and an area of the microcavity 305 may be configured according to a size and resolution of the display device.

The common electrode 270 may be made of a transparent metal material, such as at least one of indium tin oxide (ITO) and indium zinc oxide (IZO). A predetermined voltage may be applied to the common electrode 270, and an electric field may be generated between the pixel electrode 191 and the common electrode 270.

A first-type alignment layer 11 (or first alignment layer 11, for conciseness) is formed on the pixel electrode 191. The first alignment layer 11 may also be formed directly on a portion of the first insulating layer 240 that is not covered by the pixel electrode 191. In an embodiment, an insulating layer 250 (illustrated in FIG. 4) may be implemented between the first alignment layer 11 and the pixel electrode 191.

A second-type alignment layer 21 (or second alignment layer 21, for conciseness) is formed on the common electrode 270. The second alignment layer 21 is disposed between the common electrode 270 and the first alignment layer 11.

The first alignment layer 11 and the second alignment layer 21 may be vertical alignment layers and may be made of alignment materials, such as at least one of polyamic acid, polysiloxane, and polyimide. The alignment layers 11 and 21 may be connected to each other at an edge of the pixel area PX.

A liquid crystal layer may include liquid crystal molecules 310 and may be formed in the microcavity 305 positioned between the pixel electrode 191 and the common electrode 270. The liquid crystal molecules 310 may have negative dielectric anisotropy and may be oriented in a vertical direction that is substantially perpendicular to the substrate 110 when no electric field is applied to the pixel electrode 191.

The first subpixel electrode 191h and the second subpixel electrode 191l to which the data voltage is applied generate an electric field together with a common electrode 270 to determine directions of the liquid crystal molecules 310. The luminance of light that is transmitted through the liquid crystal layer may be substantially determined by the directions (or orientations) of the liquid crystal molecules 310.

A second-type insulating layer 350 (or second insulating layer 350, for conciseness) may be formed on the common electrode 270. The second insulating layer 350 may be made of an inorganic insulating material, such as at least one of silicon nitride (SiNx), silicon oxide (SiOx), and silicon oxynitride (SiOxNy). In an embodiment, the third insulating layer may be omitted.

A roof layer 360 is formed on the second insulating layer 350. The roof layer 360 may be made of an organic material. A microcavity 305 is formed below the roof layer 360, and the shape of the microcavity 305 may be maintained by hardening the roof layer 360 through a curing process. The microcavity 305 may be positioned between the roof layer 360 and the pixel electrode 191.

A roof layer 360 is formed in each pixel area PX along a pixel row and a second valley V2, and is not formed in a first valley V1. That is, the roof layer 360 is not formed between a first subpixel area PXa and a second subpixel area PXb. A microcavity 305 is formed below each roof layer 360 in each of the first subpixel area PXa and the second subpixel area PXb. In the second valley V2, a portion of a roof layer 360 may be disposed between two microcavities 305. A thickness of the portion of the roof layer 360 positioned at the second valley V2 may be larger than a thickness of another portion of the roof layer 360 positioned in each of the first subpixel area PXa and the second subpixel area PXb. An upper surface and sides of the microcavity 305 may be covered by the roof layer 360.

An injection hole 307 for exposing a part of (and/or for access to) the microcavity 305 is formed in at least one of the common electrode 270, the second insulating layer 350, and the roof layer 360. Injection holes 307 may face each other at edges of the first subpixel area PXa and the second subpixel area PXb. In an embodiment, a first injection holes 307 may correspond to a lower side of the first subpixel area PXa to allow access to a first microcavity 305 that overlaps the first subpixel electrode 191h, and a second injection hole 307 may correspond to an upper side of the second subpixel area PXb to allow access to a second microcavity 305 that overlaps the second pixel electrode 191l. An aligning agent or a liquid crystal material may be injected into a microcavity 305 through a corresponding injection hole 307.

The common electrode 270, the second insulating layer 350, and the roof layer(s) 360 may have similar shapes or similar patterns in some areas in a plan view of the display device. The shape (or pattern) of the common electrode 270, the shape (or pattern) of the second insulating layer 350, and the shape (or pattern) of a roof layer 360 may be different from each other near the injection holes 307.

A boundary of the common electrode 270 may be the same as (or overlap) a boundary of a roof layer 360 or may be positioned on the inner side of the boundary of a roof layer 360 (in a plan view of the display device), without protruding beyond the roof layer 360. In an embodiment, an edge line of a roof layer 360 may overlap an edge line of the common electrode 270. In an embodiment, an edge line of a roof layer 360 may be positioned between an edge line of the common electrode 270 and an edge line of an associated injection hole 307 in a plan view of the display device, wherein the associated injection hole 307 is configured to allow access to an associated microcavity 305, and wherein the common electrode 270 is positioned between the associated microcavity 305 and the roof layer 360. That is, an edge portion of the roof layer 360 may not overlap the common electrode 270. In an embodiment, the edge portion of the roof layer may have a tapered shape with an edge surface (or side surface) extending in a first direction, and an edge portion of the common electrode 270 may have a reversely-tapered shape with an edge surface (or side surface) extending in a second direction that is different from the first direction. A first surface (e.g., top side surface) of the roof layer 360, a second surface (e.g., bottom side surface) of the roof layer 360, a first surface (e.g., top side surface) of the common electrode 270, and a second surface (e.g., bottom side surface) of the common electrode 270 may overlap each other. The second surface of the roof layer 360 and the first surface of the common electrode 270 may be disposed between the first surface of the roof layer 360 and the second surface of the common electrode 270. The first surface of the roof layer 360 may be smaller than the second surface of the roof layer 360. The first surface of the common electrode 270 may be larger than the second surface of the common electrode 270. The larger first surface of the common electrode 270 may enable the common electrode 270 securely attach to the second insulating layer 350. The smaller second surface of the common electrode 270 may prevent unwanted electrical connection. Advantageously, the common electrode 270 may be satisfactorily insulated and stably positioned, and unwanted electrical connection between the common electrode 270 and other conductive elements (e.g., a pixel electrode 191) may be prevented.

A boundary of the second insulating layer 350 may be the same as (or overlap) a boundary of the roof layer 360 or may be positioned on the outer side of the boundary of the roof layer 360 (in a plan view of the display device).

In an embodiment, a boundary of the second insulating layer 350 may be formed on the inner side of a boundary of the roof layer 360. An edge portion of the second insulating layer 350 that is associated with the boundary of the second insulating layer 350 may have a reversely-tapered shape that has a relatively larger top side surface and a relatively smaller bottom side surface.

A third-type insulating layer 370 (or third insulating layer 370, for conciseness) may be formed on the roof layer 360. The third insulating layer 370 may be made of an inorganic insulating material, such as at least one of silicon nitride (SiNx), silicon oxide (SiOx), and silicon oxynitride (SiOxNy). The third insulating layer 370 may cover an upper surface (or top side surface) and a side (or edge side surface disposed at an angle with respect to the top side surface) of the roof layer 360. The third insulating layer 370 may protect the roof layer 360, which may be made of an organic material.

A boundary of the fourth insulating layer 370 may overlap at least one of a boundary of the common electrode 270, a boundary of the second insulating layer 350, and a boundary of the roof layer 360 (in a plan view of the display device). A boundary of the third insulating layer 370 may be different from or may not overlap boundaries of the common electrode 270, the second insulating layer 350, and the roof layer 360 near the injection hole 307 (in a plan view of the display device).

A boundary of the common electrode 270 may be positioned on the inner side of a boundary of the third insulating layer 370 (in a plan view of the display device). The common electrode 270 may be smaller than the third insulating layer 370 in a plan view of the display device.

A boundary of the second insulating layer 350 may be the same as (or overlap) a boundary of the third insulating layer 370 (in a plan view of the display device).

In an embodiment, a boundary of the second insulating layer 350 may be formed on the inner side of a boundary of the roof layer 360 (in a plan view of the display device). The second insulating layer 350 may be smaller than the roof layer 360 in a plan view of the display device.

The third insulating layer 370 may contact the second insulating layer 350. Therefore, the roof layer 360 may be substantially enclosed by the third insulating layer 370 and the second insulating layer 350.

In an embodiment, the third insulating layer 370 may be omitted.

An encapsulation layer 390 may be formed on and/or may overlap at least one of the third insulating layer 370, the roof layer 360, the second insulating layer 350, and the common electrode 270. The encapsulation layer 390 may cover the injection hole 307, which may allow access to the associated microcavity 305. The encapsulation layer 390 may seal the microcavity 305 so that the liquid crystal molecules 310 formed in the microcavity 305 are not discharged outside. The encapsulation layer 390 may directly contact the liquid crystal molecules 310 and may be made of a material that does not substantially react (e.g., chemically react) with liquid crystal molecules 310. In an embodiment, the encapsulation layer 390 may have a layer that is made of parylene.

The encapsulation layer 390 (or overcoat 390) may have a multilayer structure, such as a double layer structure or a triple layer structure. The double layer structure may include two layers made of different materials. The triple layer structure may include three layers, and materials of immediately adjacent layers are different from each other. For example, the encapsulation layer 390 may include a layer made of an organic insulating material and a layer made of an inorganic insulating material.

Although not illustrated, polarizers may be formed on upper and lower sides of the display device. The polarizers may include a first polarizer and a second polarizer. The first polarizer may be attached onto the lower side of the substrate 110, and the second polarizer may be attached onto the encapsulation layer 390.

According to embodiments of the present invention, one pixel may be divided into the first area receiving the first voltage and the second area receiving the second voltage, and different liquid crystal materials may be respectively provided in the first area and the second area. Therefore, it is possible to enable the pixels to exhibit three or more gray values with only two voltage values. Advantageously, the display device may display images with satisfactory visibility with a substantially simple driving scheme.

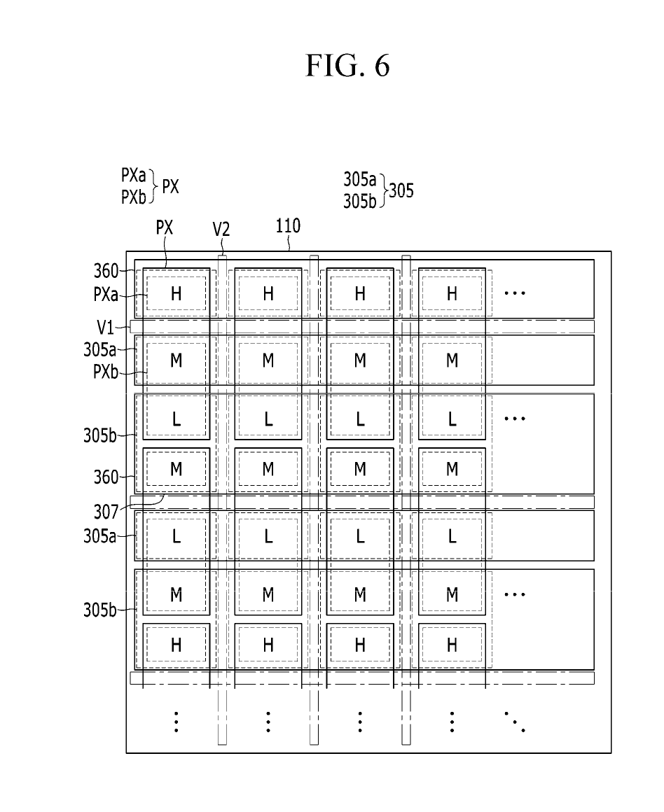

FIG. 6 is schematic plan view illustrating elements and/or structures in a display device according to an embodiments of the present invention. The display device may include constituent elements identical to or similar to one or more of the constituent elements discussed with reference to one or more of FIG. 1, FIG. 2, FIG. 3, FIG. 4, and FIG. 5. Descriptions related to the identical or similar constituent elements may not be repeated.

The display device includes a substrate 110 and a roof layer 360 formed on the substrate 110. The substrate may be made of at least one of glass and plastic.

The substrate 110 includes a plurality of pixels PX. The plurality of pixels PX may form a matrix that includes a plurality of pixel rows and a plurality of pixel columns. Each pixel PX may include one thin film transistor and one pixel electrode. Each pixel PX may include a first-type subpixel area PXa (or first area PXa) in which a first-type subpixel electrode (or first subpixel electrode), a smaller subpixel electrode, is positioned and may include a second-type subpixel area PXb (or second area PXb) in which a second-type subpixel electrode (or second subpixel electrode), a larger subpixel electrode, is positioned. The first area PXa (a smaller area) and the second area PXb (a larger area) may be aligned parallel to an extension direction of a data line and/or may be aligned in a pixel column direction.

According to an embodiment of the present invention, a second area PXb may include a first subarea and a second subarea which are aligned in a pixel column direction and are divided based on a horizontal stem portion of the second subpixel electrode positioned in the second area PXb. A part of the second area PXb positioned at an upper side of the horizontal stem portion of the second subpixel electrode is referred to as the first subarea, and the remaining area of the second area PXb positioned at a lower side of the horizontal stem portion of the second subpixel electrode is referred to as the second subarea.

A first-type valley V1 (or first valley V1) is positioned between the first area PXa and the second area PXb and may extend parallel to a gate line. A second-type valley V2 (or second valley V2) is positioned between two immediately neighboring pixel columns.

A plurality of roof layers 360 may extend parallel to the gate lines. Injection holes 307 may be positioned at first valleys V1 and may enable injection of liquid crystal materials in a process of manufacturing the display device.

Microcavities 305 may be provided between each roof layer 360 and the substrate 110 and between immediately neighboring second valleys V2. The microcavities 305 may contain liquid crystal material members.

The microcavities 305 may include first-type microcavities 305a (or first microcavities 305a) and second-type microcavities 305b (or second microcavities 305b. An opening, or injection hole 307, of a first microcavity 305a may face an opening, or injection hole 307, of an immediately neighboring second microcavity 305b.

The roof layer 360 may cover three lateral sides (among the four lateral sides of) of each microcavity 305 and may expose one lateral side of the microcavity 305 through an injection hole 307. The injection hole 307 of a first microcavity 305a positioned at a first side of a first valley V1 may face the injection hole 307 of an immediately neighboring second microcavity 305b positioned at a second side of the first valley V1.

The injection hole 307 of a first microcavity 305a may be positioned at a first lateral side of the first microcavity 305a, which is opposite a second lateral side of the first microcavity 305a. The injection hole 307 of a second microcavity 305b may be positioned at a second lateral side of a second microcavity 305b, which is opposite a first lateral side of the second microcavity 305b and may be opposite a first lateral side of a first microcavity 305a. The second lateral side of the first microcavity 305a is covered by the roof layer 360, and the first lateral side of the second microcavity 305b is covered by the roof layer 360.

In an embodiment, as illustrated in FIG. 6, a first microcavity 305a may overlap a first subarea of the second area PXb (and a first part of a second subpixel electrode) included in a first pixel PX, and a second microcavity 305b may overlap a second subarea of the second area PXb (and a second part of the second subpixel electrode) of the pixel PX and the first area PXa (and the first subpixel electrode) of a second pixel PX, wherein the second pixel PX immediately neighbors the first pixel PX in a pixel column direction.

Microcavity pairs, each including a first microcavity 305a and a second microcavity 305b, may be disposed between two immediately neighboring first valleys along the extension direction of a gate line.

A plurality of second microcavities 305b positioned in the first microcavity row may be arranged along the extension direction of the gate line, and a plurality of first microcavities 305a positioned in the second microcavity row may be arranged along in the extension direction of the gate line. The first first-type valley V1 may be positioned between the plurality of second microcavities 305b and the plurality of first microcavities 305a.

The microcavities 305a and 305b may contain liquid crystal materials having different properties. For example, a first liquid crystal material may be provided through the injection holes 307 positioned in the first valley V1 positioned in the first pixel row, and a second liquid crystal material may be provided through the injection holes 307 positioned in the first valley V1 positioned in the second pixel row.

A material property of the first liquid crystal material may be different from a material property of the second liquid crystal material. In an embodiment, a dielectric anisotropy, a response speed, and/or a transmittance of the first liquid crystal material may be different from a dielectric anisotropy, a response speed, and/or a transmittance of the second liquid crystal material. Accordingly, even if subpixel electrodes are driven with the same voltage, luminance of light passing through subpixel portions may be different. Advantageously, it is possible to improve visibility of images displayed by the display device.

More particularly, when the first liquid crystal material is injected through the injection holes 307 positioned in the first pixel row (i.e., in first first-type valley V1), the first liquid crystal material is injected into the plurality of second microcavities 305b positioned in the first microcavity row and the plurality of first microcavities 305a positioned in the second microcavity row.

When the second liquid crystal material is injected into the injection hole 307 positioned in the second pixel row (i.e., in the second first-type valley V1), the second liquid crystal material may be injected into the second microcavities 305b positioned in the third microcavity row and the first microcavities 305a positioned in the fourth microcavity row.

According to an embodiment of the present invention, different liquid crystal materials may be provided for immediately adjacent pixels in different pixel rows, according to positions of the corresponding injection holes.

According to an embodiment of the present invention, a first voltage may be applied to first areas PXa (or first subpixel electrodes), a second voltage may be applied to second areas PXb (or second subpixel electrodes), and the first voltage is larger than the second voltage. In an embodiment, a gray value at each area may be implemented according to the kind of liquid crystal material positioned the area as well as the voltage applied to the subpixel electrode in the area.

For example, a first area PXa, with the first liquid crystal material (which has a relative higher dielectric anisotropy) may exhibit a high gray value. A first area PXa with the second liquid crystal material (which has a relatively low dielectric anisotropy) may exhibit an intermediate gray value.

A second area PXb with the first liquid crystal material may exhibit an intermediate gray value. A second area PXb with the second liquid crystal material may exhibit a low gray value.

In an embodiment, the second microcavities 305b positioned in the first microcavity row may overlap first areas PXa (which receive the first voltage), and may contain the first liquid crystal material (which is injected through the associated injection holes 307 positioned in the first pixel row). Accordingly, the subpixel areas PXa associated with these second microcavities 305b may exhibit the high gray value.

The first microcavities 305a positioned in the second microcavity row may overlap first subareas of second areas PXb (or first portions of second subpixels), which receive the second voltage, and may contain the first liquid crystal material (which is injected through the associated injection holes 307 positioned in the first pixel row). Accordingly, the first subareas of the second subpixel areas PXb associated with these first microcavities 305a may exhibit a first intermediate gray value.

The second microcavities 305b positioned in the third microcavity row may contain the second liquid crystal material (which is injected through the associated injection holes 307 positioned in the second pixel row) and may overlap second subareas of second subpixel areas PXb of a set of pixels PX and first subpixel areas PXa of another set of pixels PX. The second subareas of second subpixel areas PXb associated with these second microcavities 305b may receive the second voltage and may exhibit the low gray value, and the first subpixel areas PXa associated with these second microcavities 305b may receive the first voltage and may exhibit a second intermediate gray value. Because of the material difference and/or the voltage difference, the second immediate gray value may be unequal to the first immediate gray value.

The first microcavity 305a positioned in the fourth microcavity row may contain the second liquid crystal material (which is injected through the associated injection holes 307 positioned in the second pixel row). The first subareas of second subpixel areas PXb associated with these first microcavities 305a may receive the second voltage and exhibit the low gray value.

In an embodiment, a first microcavity 305a may overlap a first roof layer 360, a second microcavity 305b immediately neighboring the first microcavity 305a may overlap a second roof layer 360, and the first roof layer 360 may be spaced from the second roof layer 360 and may extend parallel to the second roof layer 360.

In an embodiment, a first microcavity 305a and a second microcavity 305b may be divided by a portion of roof layer 360.

The first microcavities 305a positioned in the second microcavity row and the second microcavities 305b positioned in the third microcavity row may be partitioned by a portion of a roof layer 360. These first microcavities 305a may overlap the first subareas of second areas PXb (and first portions of second subpixel electrodes 191l), and these second microcavities 305b may overlap the second subareas of these second area PXb (and second portions of these second subpixel electrodes 191l) and the first areas PXa (and the first subpixels) of another set of pixels. In an embodiment, the portion of the roof layer 360 may overlap horizontal stem portions of these second subpixel electrodes 191l positioned in the second areas PXb.

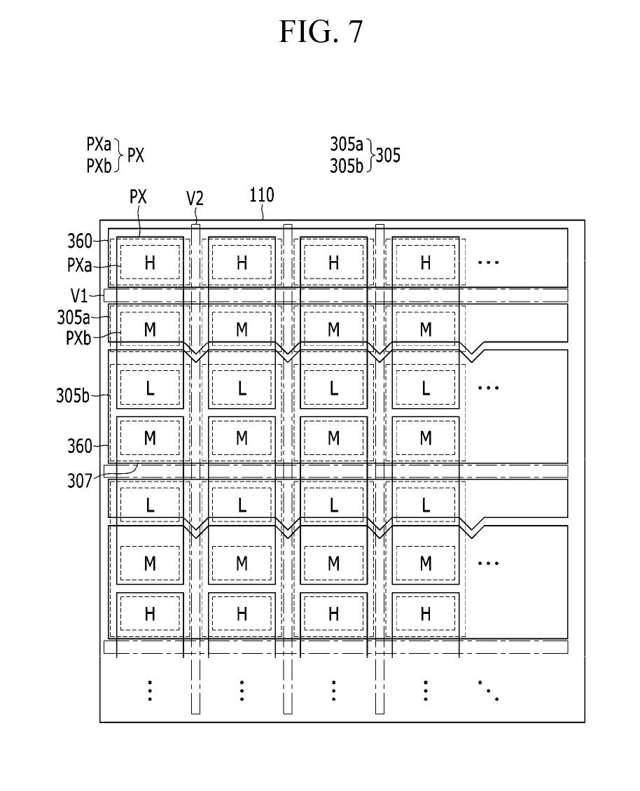

FIG. 7 is a schematic plan view illustrating elements and/or structures in a display device according to an embodiment of the present invention. The display device may include constituent elements identical to or similar to one or more of the constituent elements discussed with reference to one or more of FIG. 1, FIG. 2, FIG. 3, FIG. 4, FIG. 5, and FIG. 7. Descriptions related to the identical or similar constituent elements may not be repeated.

In an embodiment of the present invention, a shape of a roof layer 360 of the display device illustrated in FIG. 7 may be different from that of a display device illustrated in FIG. 6.

According to an embodiment of the present invention, referring to FIG. 7, a portion of a roof layer 360 may be positioned between the first microcavities 305a of the second microcavity row and the second microcavities 305b of the third microcavity row. The portion of the roof layer 360 may include obliquely formed sections that overlap fine branch portions 194l included in second subpixel electrodes 191l positioned in the associated second areas PXb. This is for the purpose of controlling image texture, which may be generated around the roof layer, by arranging liquid crystal molecules around the roof layer 360 in same directions as directions of the fine branch portions.

According to embodiments of the present invention, the liquid crystal display device may generate three or more different gray values with only two different voltages. Advantageously, with a substantially simple driving scheme, the display device may display images with improved visibility.

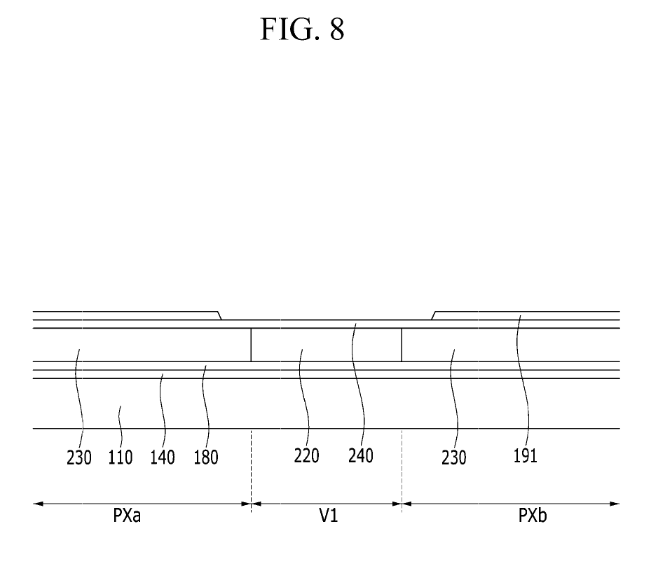

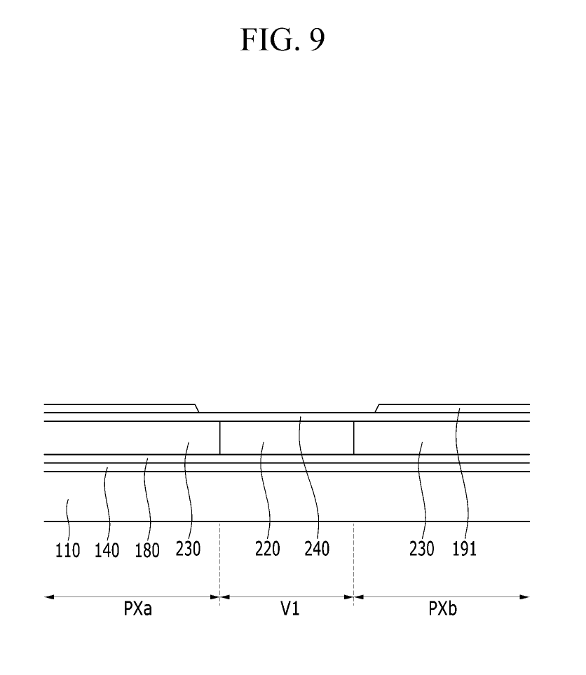

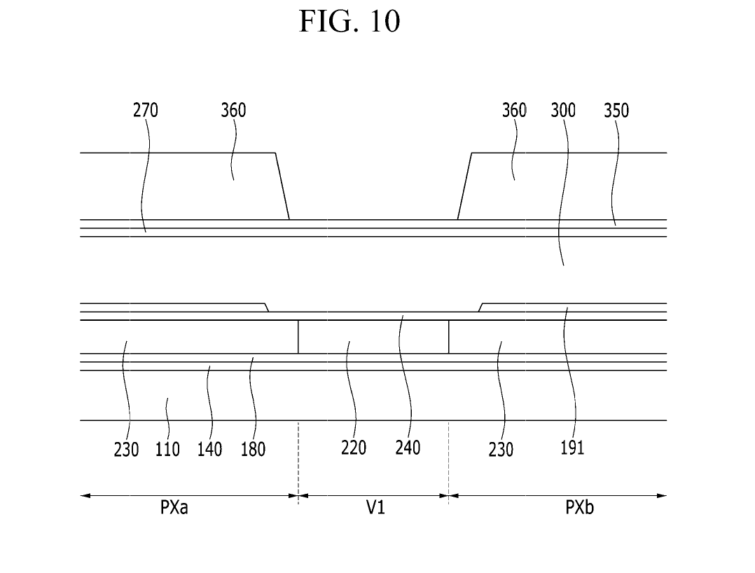

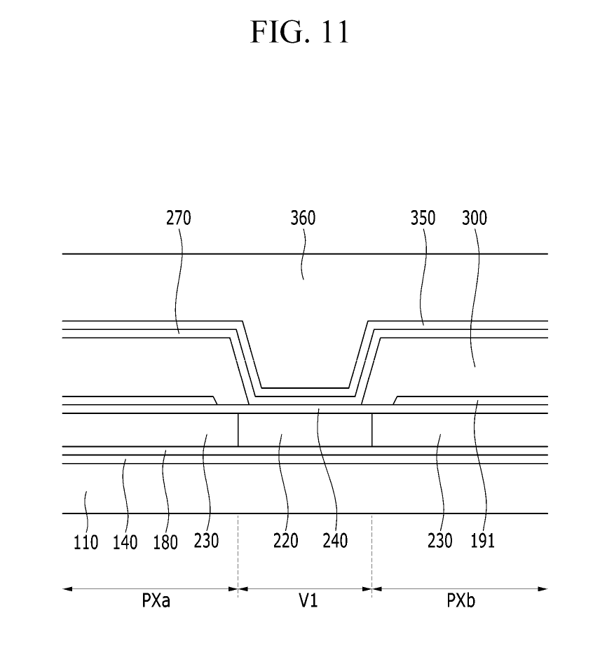

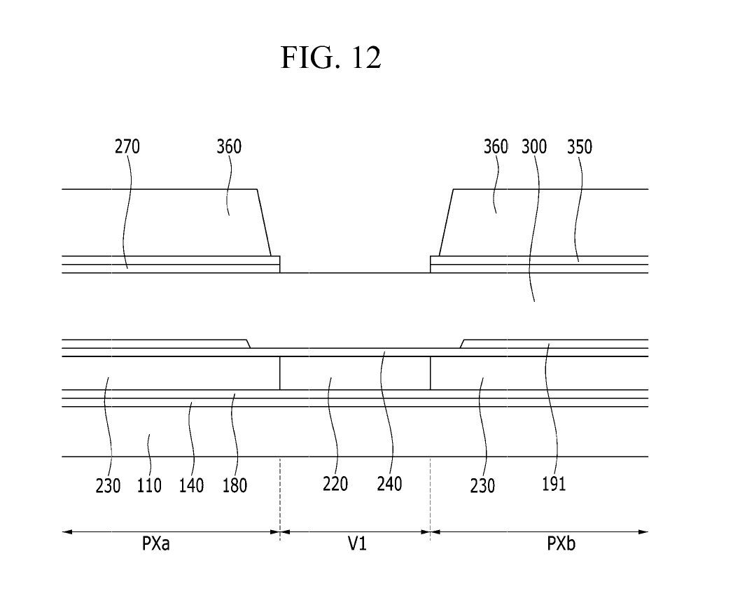

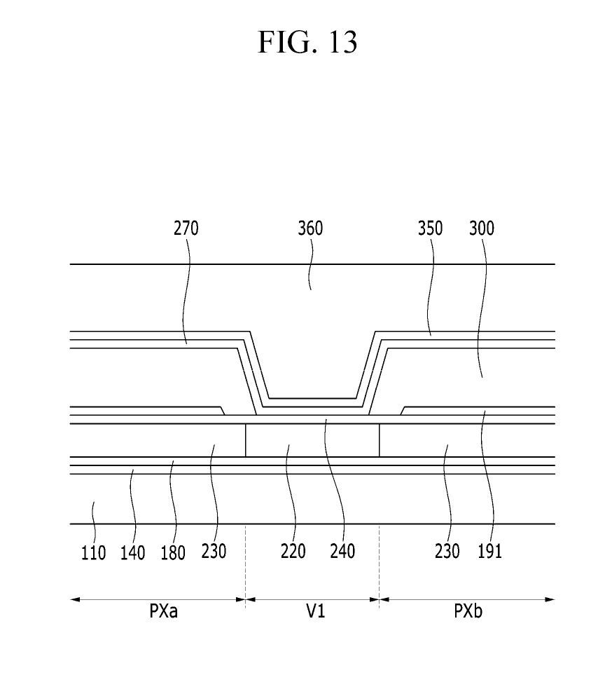

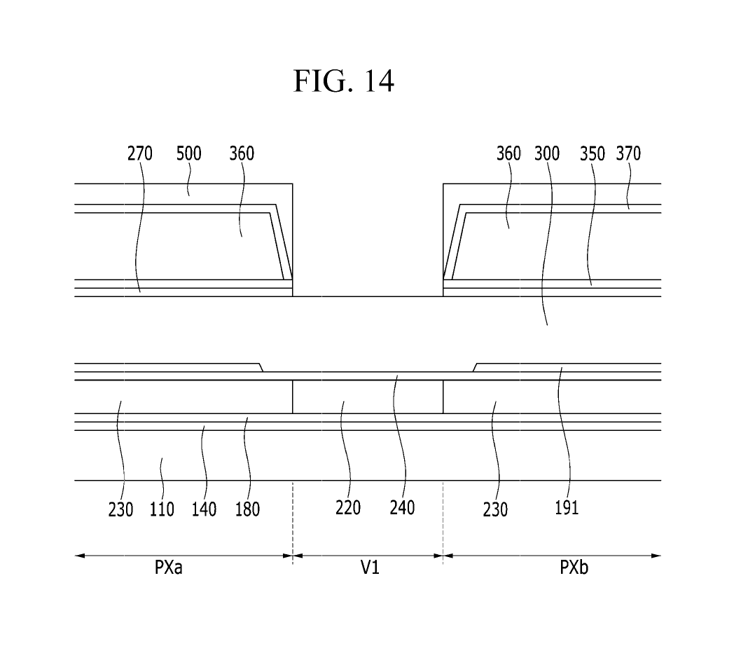

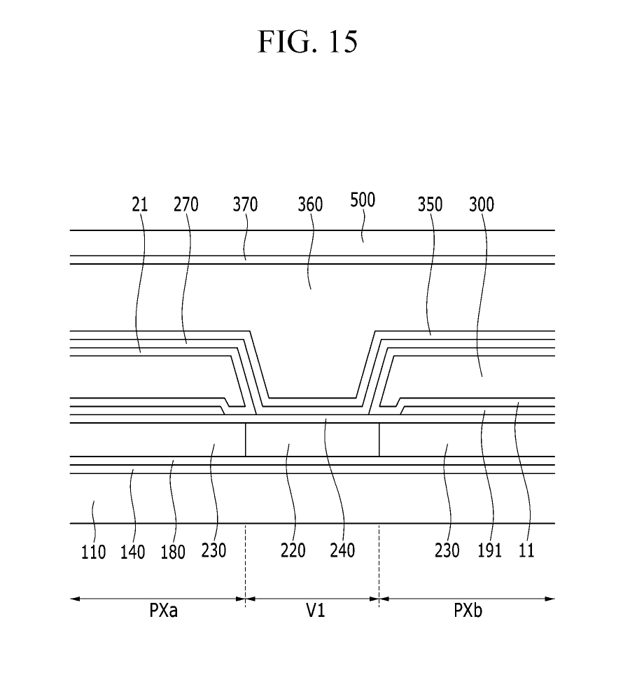

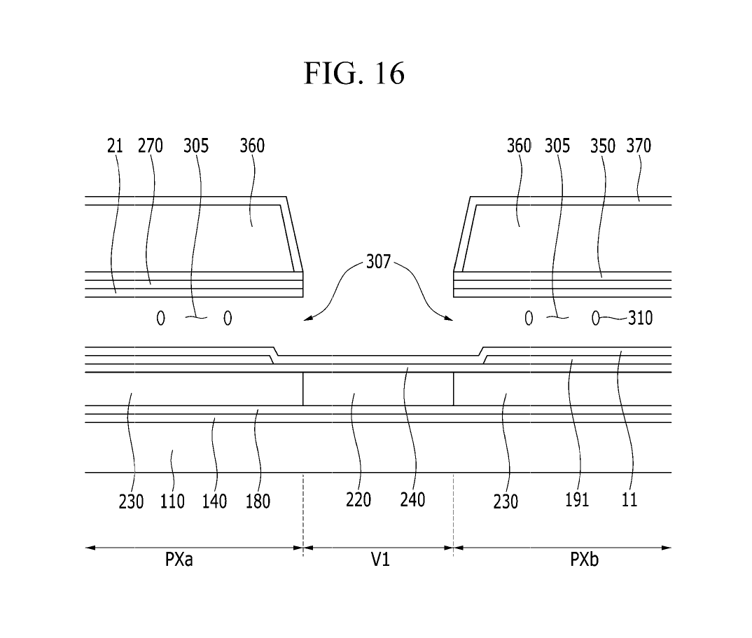

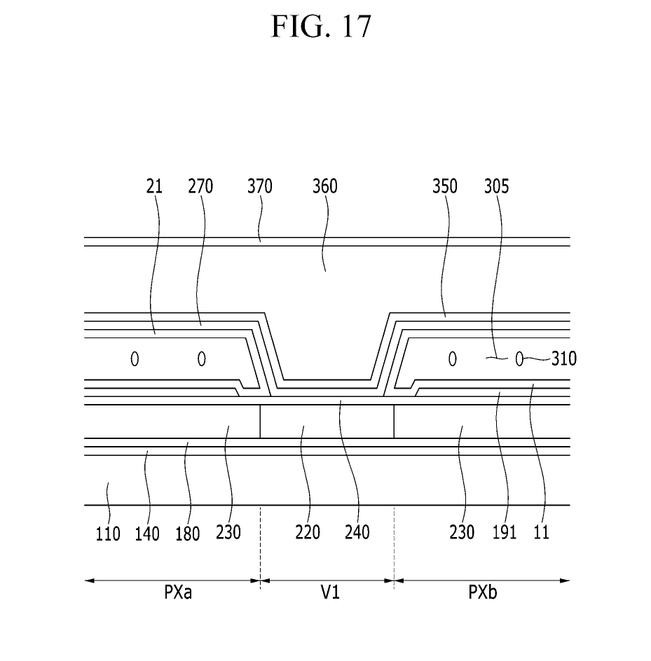

FIGS. 8 to 17 are schematic cross-sectional views illustrating elements and/or structures formed in a process of manufacturing a display device according to an embodiment of the present invention.

A gate line 121 and a step-down gate line 123 (both extending in one direction) are formed on a substrate 110, which may be made of glass, plastic, etc. Substantially simultaneously, a first gate electrode 124h, a second gate electrode 124l, and a third gate electrode 124c, which protrude from the gate line 121, are formed.

Substantially simultaneously, a storage electrode line 131 may be formed. The storage electrode line 131 may be spaced apart from the gate line 121, the step-down gate line 123, and the gate electrodes 124h, 124l, and 124c.

Subsequently, a gate insulating layer 140 is formed on the entire surface of the substrate 110 and may cover the gate line 121, the step-down gate line 123, the gate electrodes 124h, 124l, and 124c, and the storage electrode line 131. The gate insulating layer 140 may be formed of an inorganic insulating material, such as silicon oxide (SiOx) or silicon nitride (SiNx). The gate insulating layer 140 may have a single layer structure or a multiple layer structure.

Subsequently, a first semiconductor 154h, a second semiconductor 154l, and a third semiconductor 154c are formed by depositing a semiconductor material (such as at least one of amorphous silicon, polycrystalline silicon, and metal oxide) on the gate insulating layer 140 and then patterning the deposited semiconductor material. The first semiconductor 154h may be positioned on the first gate electrode 124h, the second semiconductor 154l may be positioned on the second gate electrode 124l, and the third semiconductor 154c may be positioned on the third gate electrode 124c.

Subsequently, a data line 171, which extends in the other direction, is formed by depositing a metal material and then patterning the deposited metal material. The metal material may have a single layer structure or a multiple layer structure.

Substantially simultaneously, a first source electrode 173h, with protrudes from the data line 171 above the first gate electrode 124h, and a first drain electrode 175h, which is spaced apart from the first source electrode 173h, are formed. Substantially simultaneously, a second source electrode 173l, which is connected to the first source electrode 173h, and a second drain electrode 175l, which is spaced apart from the second source electrode 173l, are formed. Substantially simultaneously, a third source electrode 173c, which extends from the second drain electrode 175l, and a third drain electrode 175c, which is spaced apart from the third source electrode 173c, are formed.

The semiconductors 154h, 154l, and 154c, the data line 171, the source electrodes 173h, 173l, and 173c, and the drain electrodes 175h, 175l, and 175c may be formed by sequentially depositing a semiconductor material and a metal material and then patterning the semiconductor material and the metal material in a same patterning process. In an embodiment, the first semiconductor 154h may overlap a portion of the data line 171.

The gate electrodes 124h, 124l, and 124c, the source electrodes 173h, 173l, and 173c, and the drain electrodes 175h, 175l, and 175c form thin film transistors (TFTs) Qh, Ql, and Qc together with the semiconductors 154h, 154l, and 154c, respectively.

Subsequently, a passivation layer 180 is formed on the data line 171, the source electrodes 173h, 173l, and 173c, the drain electrodes 175h, 175l, and 175c, and the semiconductors 154h, 154l, and 154c exposed between the respective source electrodes 173h, 173l, and 173c and the respective drain electrodes 175h, 175l, and 175c. The passivation layer 180 may be made of an organic insulating material and/or an inorganic insulating material. The passivation layer 180 may have a single layer structure or a multiple layer structure.

Subsequently, a color filter 230 is formed in each pixel area PX on the passivation layer 180. A color filter 230 or a portion of a color filter 230 is formed in each of the first subpixel area PXa and the second subpixel area PXb. No color filter may be formed at the first valley V1. Color filters 230 having the same color may be formed in a column direction in columns of the plurality of pixel areas PX. For forming color filters 230 having three colors, a first colored color filter 230 may be first formed and then a second colored color filter 230 may be formed by shifting a mask. Subsequently, the second colored color filter 230 may be formed and then a third colored color filter may be formed by shifting a mask.

Subsequently, a light blocking member 220 is formed on a boundary of each pixel area PX and may be formed on the passivation layer 180 and the thin film transistors. The light blocking member 220 may also be formed at the first valley V1 positioned between the first subpixel area PXa and the second subpixel area PXb.

The light blocking member 220 may be formed at one or more edges of each pixel area PX. The light blocking member 220 may overlap a support member 365 that is subsequently formed.

In an embodiment, the light blocking member 220 is formed after the color filters 230 have been formed. In an embodiment, the light blocking member 220 may be formed before formation of the color filters 230.

Subsequently, a first insulating layer 240, which may be made of an inorganic insulating material such as at least one of silicon nitride (SiNx), silicon oxide (SiOx), and silicon oxynitride (SiOxNy), is formed on the color filter 230 and the light blocking member 220.

Subsequently, a first contact hole 185h is formed by etching the passivation layer 180, the first light blocking member 220, and the first insulating layer 240 so as to expose a part of the first drain electrode 175h, and a second contact hole 185l is formed so as to expose a part of the second drain electrode 175l.

Subsequently, a first subpixel electrode 191h is formed in the first subpixel area PXa, and a second subpixel electrode 191l is formed in the second subpixel area PXb, by depositing and patterning a transparent metal material, such as at least one of indium tin oxide (ITO) and indium zinc oxide (IZO), on the first-type insulating layer 240. The first subpixel electrode 191h and the second subpixel electrode 191l are separated from each other with the first valley V1 being positioned therebetween. The first subpixel electrode 191h is connected to the first drain electrode 175h through the first contact hole 185h, and the second subpixel electrode 191l is connected to the second drain electrode 175l through the second contact hole 185l.

Horizontal stems 193h and 193l and vertical stems 192h and 192l crossing the horizontal stems 193h and 193l are formed in the first subpixel electrode 191h and the second subpixel electrode 191l. Further, a plurality of minute branches 194h and 194l, which obliquely extend from the horizontal stems 193h and 193l and the vertical stems 192h and 192l, is formed.

Referring to FIGS. 10 and 11, a photosensitive organic material is applied onto the pixel electrode 191, and a sacrificial layer 300 is formed by a photo process. The sacrificial layer 300 may be formed in a plane shape in which several “H” shapes are connected, for subsequently forming injection holes are alternately arranged in pixel columns and/or pixel rows.

According to an embodiment of the present invention, the sacrificial layer 300 may include portions formed in areas in which injection holes are to be formed in the first valley formed, and portions of the sacrificial layer 300 may be removed from areas in which no injection holes are to be formed.

A common electrode 270 material layer may be formed by depositing a transparent metal material, such as at least one of indium tin oxide (ITO) and indium zinc oxide (IZO), on the sacrificial layer 300.

Subsequently, a second insulating layer 350 material layer may be formed on the common electrode 270 material layer using an inorganic insulating material, such as at least one of silicon nitride (SiNx), silicon oxide (SiOx), and silicon oxynitride (SiOxNy).

Subsequently, a roof layer 360 may be formed by coating and patterning an organic material on the second insulating layer 350 material layer. A portion of the organic material positioned at the first valley V1 may be removed. As a result, the roof layers 360 may be formed along a plurality of pixel rows.

Referring to FIGS. 12 and 13, the second insulating layer 350 material layer and the common electrode 270 are material layer may be patterned by using the roof layer 360 as a mask. First In an embodiment, the second insulating layer 350 material layer may be is dry-etched by using the roof layer 360 as a mask, and then subsequently the common electrode 270 is material layer may be wet-etched using the roof layer 360 and/or the remaining second insulating layer 350 material layer as a mask.

Referring to FIGS. 14 and 15, a third insulating layer 370 material layer may be formed of an inorganic insulating material, such as at least one of silicon nitride (SiNx), silicon oxide (SiOx), and silicon nitride oxide (SiOxNy), on the roof layer 360.

Subsequently, a photoresist 500 material layer may be coated on the third insulating layer 370 and may be patterned by a photolithography process. A portion of the photoresist 500 material layer positioned at the first valley V1 may be removed, and a patterned photoresist 500 may remain on the third insulating layer 370 material layer. The third insulating layer 370 material layer may be etched using the patterned photoresist 500 as a mask. A portion of the third insulating layer 370 material layer positioned at the first valley V1 may be removed, and the resulted third insulating layer 370 may remain on the roof layer 360.

The third insulating layer 370 may cover the upper surface and one or two side surfaces of the roof layer 360 to protect the roof layer 360. A boundary of the third insulating layer 370 may be positioned beyond a boundary of the roof layer 360 (in a plan view of the display device). The third insulating 370 may extend and/or protrude beyond the roof layer 360. An edge portion of the third insulating layer 370 does not overlap the roof layer 360 in a direction perpendicular to the substrate 110.

Portions of two immediately neighboring third insulating layers 370 may be positioned between two immediately neighboring roof layers 360. A portion of a first third-type insulating layer 370 and a portion of a second third-type insulating layer 370 that immediately neighbors the first third-type insulating layer 370 may be positioned between a first roof layer 360 and a second roof layer 360 that immediately neighbors the first roof layer 360.

The common electrode 270 material layer may be over-etched using the roof layer 360 as a mask to produce the common electrode 270. As a result, the common electrode 270 may be completely covered by the third insulating layer 370, and the third insulating layer 370, which extends beyond the roof layer 360, may extend beyond the common electrode 270. An edge portion of the third insulating layer 370 does not overlap the common electrode 270 in a direction perpendicular to the substrate 110.

The shape and/or pattern of the second insulating layer 350 may be the same as the shape and/or pattern of the third insulating layer 370 in a plan view of the display device. An edge portion of the third insulating layer 370 may directly contact an edge portion of the second insulating layer 350.

Referring to FIGS. 16 and 17,

the sacrificial layer 300 is fully removed by supplying at least one of a developer, a stripper solution, etc. to the sacrificial layer 300. Alternatively or additionally, the sacrificial layer 300 may be removed using an ashing process.

When the sacrificial layer 300 is removed, microcavities 305 may be formed at positions where the sacrificial layer 300 has been positioned.

The pixel electrode 191 and the common electrode 270 are spaced apart from each other with a microcavity 305 being positioned therebetween, and the pixel electrode 191 and the roof layer 360 are spaced apart from each other with the microcavity 305 being positioned therebetween. The common electrode 270 and the roof layer 360 may cover the upper surface and may at least partially cover sides of the microcavity 305.

The microcavity 305 is exposed at an opening formed as a result of removal of portions of the roof layer 360, the second insulating layer 350, and the common electrode 270. The opening is called an injection hole 307. An injection hole 307 may be formed along a first valley V1. In an embodiment, a first injection hole 307 may be formed at a first edge of the first subpixel area PXa, a second injection hole 307 may be formed at a first edge of the second subpixel area PXb. The first edge of the first subpixel area PXa and the first edge of the second subpixel area PXb may immediately neighbor each other and may be positioned between a second edge of the first subpixel area PXa and a second edge of the second subpixel area PXb. In an embodiment, the first edge of the first subpixel area PXa may be a lower edge of the first subpixel area PXa, and the first edge of the second subpixel area PXb may be an upper edge of the second subpixel area PXb. In an embodiment, an injection hole 307 may be formed along a second valley V2.

Subsequently, the roof layer 360 may be cured by applying heat to at least one of the roof layer 360 and the substrate 110. As a result, the shape of the space 305 may be maintained by the roof layer 360.

Subsequently, an aligning agent containing an alignment material may be provided on the substrate 110 using a spin coating method and/or an inkjet method. The aligning agent may be provided (e.g., injected) into the microcavity 305 through the injection hole 307. Subsequently, a curing process may be performed. As a result, a solution component may be evaporated, and an alignment material may remain on the inner wall of the microcavity 305 to form alignment layers 11 and 21.

The first alignment layer 11 may be formed on the pixel electrode 191, and the second alignment layer 21 may be formed on common electrode 270. The first alignment layer 11 and the second alignment layer 21 may overlap each other with the microcavity 305 being positioned therebetween and may be connected to each other at an edge of the pixel area PX.

In an embodiment, the alignment layers 11 and 21 may be configured to substantially align liquid crystal molecules in a vertical direction that is substantially perpendicular to the substrate 110 (i.e., perpendicular to a surface of the substrate 110 that overlaps the roof layer 360, except, for example, at positions where bead members 400 are located. In an embodiment, a process of irradiating UV light on the alignment layers 11 and 21 may be performed; as a result, the alignment layers 11 and 21 may be configured to substantially align liquid crystal molecules in a horizontal direction that is substantially parallel to the substrate 110.

Subsequently, liquid crystal materials that include liquid crystal molecules 310 may be provided (e.g., dropped) on the substrate 110 using an inkjet method or a dispensing method. A liquid crystal material may be provided (e.g., injected) into a microcavity 305 through a corresponding injection hole 307.

In an embodiment, only one injection hole is formed in one microcavity. The plurality of injection holes 307 positioned in the different rows may be provided, and the liquid crystal materials having different properties may be supplied through the different injection holes 307.

Referring to FIG. 1, when a first liquid crystal material is supplied through the injection holes 307 positioned in the first pixel row, the first liquid crystal material is injected into the microcavities 305 positioned in the odd numbered microcavity columns, in the first microcavity row, and in the second microcavity row.

Referring to FIG. 1, when a second liquid crystal material is supplied through the injection holes 307 positioned in the second pixel row, the second liquid crystal material is injected into the microcavities 305 positioned in the even numbered column, in the second microcavity row and the third microcavity row. In an embodiment, two liquid crystal materials having two different properties are respectively injected into two microcavities 305 adjacent in the row direction.

Referring to FIGS. 3 to 5, an encapsulation layer 390 (or overcoat 390) may be formed by depositing a material that does not substantially (chemically) react with the liquid crystal molecules 310 on the third insulating layer 370. The encapsulation layer 390 is formed to cover the injection hole 307 for sealing the microcavity 305.

Subsequently, although not illustrated, a first polarizer may be attached onto the lower side of the substrate 110, and a second polarizer may be attached onto the encapsulation layer 390.

According to embodiments of the present invention, a liquid crystal display device may implement three or more different gray values in different subpixel areas by applying only two different voltages. Advantageously, with a substantially simple driving scheme, the display device may display images with satisfactory visibility.

According to embodiments of the invention, a display device may include only one substrate. Advantageously, the thickness, the weight, the manufacturing cost, and/or the manufacturing time of the display device may be minimized

While embodiments of this invention have been described, the invention is not limited to the described embodiments. The invention is intended to cover various modifications and equivalent arrangements included within the spirit and scope of the appended claims.

What is claimed is:

1. A display device comprising:
a first pixel, which includes a first first-pixel subpixel electrode and a second first-pixel subpixel electrode;
a second pixel, which neighbors the first pixel and includes a first second-pixel subpixel electrode and a second second-pixel subpixel electrode;
a first liquid crystal layer, which is formed of a first liquid crystal material and overlaps the second first-pixel subpixel electrode; and
a second liquid crystal layer, which is formed of a second liquid crystal material and overlaps the first second-pixel subpixel electrode, wherein a material property of the first liquid crystal material is different from a material property of the second liquid crystal material.

2. The display device of claim 1, further comprising:
a gate line, which is electrically connected to a gate electrode of the first pixel, wherein the first pixel is aligned with the second pixel in a direction parallel to an extension direction of the gate line.

3. The display device of claim 1, further comprising:
a third liquid crystal layer, which is formed of the first liquid crystal material and overlaps the first first-pixel subpixel electrode; and
a fourth liquid crystal layer, which is formed of the second liquid crystal material and overlaps the second second-pixel subpixel electrode.

4. The display device of claim 3, further comprising:
a third pixel, which includes a first third-pixel subpixel electrode and a second third-pixel subpixel electrode,
wherein the fourth liquid crystal layer overlaps the first third-pixel subpixel electrode.

5. The display device of claim 4, further comprising:
a data line, which is electrically connected to a source electrode of the second pixel, wherein the second electrode is aligned with the third pixel in a direction parallel to an extension direction of the data line.

6. The display device of claim 1, further comprising:
a third pixel, which includes a first third-pixel subpixel electrode and a second third-pixel subpixel electrode,
wherein the first liquid crystal layer overlaps the first third-pixel subpixel electrode.

7. The display device of claim 6, further comprising:
a data line, which is electrically connected to a source electrode of the first pixel, wherein the first pixel is aligned with the third pixel in a direction parallel to an extension direction of the data line.

8. The display device of claim 6, further comprising:
a third liquid crystal layer, which is formed of the first liquid crystal material and overlaps the second third-pixel subpixel electrode.

9. The display device of claim 1,
wherein the first liquid crystal layer overlaps a first portion of the second first-pixel subpixel electrode, and
wherein the second liquid crystal layer overlaps a second portion of the second first-pixel subpixel electrode.

10. The display device of claim 9, further comprising:
a data line, which is electrically connected to a source electrode of the first pixel, wherein the first pixel is aligned with the second pixel in a direction parallel to an extension direction of the data line.

11. The display device of claim 9, further comprising:
a third liquid crystal layer, which is formed of the second material and overlaps a first portion of the second second-pixel electrode.

12. The display device of claim 11, further comprising:
a fourth liquid crystal layer, which is formed of the first material and overlaps a second portion of the second second-pixel electrode.

13. The display device of claim 12, further comprising:
a third pixel, which includes a first third-pixel subpixel electrode and a second third-pixel subpixel electrode,
wherein the fourth liquid crystal layer overlaps the first third-pixel subpixel electrode.

14. The display device of claim 13, further comprising:
a data line, which is electrically connected to a source electrode of the second pixel, wherein the second pixel is aligned with the third pixel in a direction parallel to an extension direction of the data line.

15. The display device of claim 9, further comprising:
a roof layer, which overlaps the first liquid crystal layer and the second liquid crystal layer,
wherein a first portion of the roof layer is positioned between the first liquid crystal layer and the second liquid crystal layer, and
wherein a second portion of the roof layer is oblique with respect to the first portion of the roof layer in a plan view of the display device.

16. The display device of claim 15, wherein the first portion of the roof layer overlaps a stem portion of the second first-pixel subpixel electrode.

17. The display device of claim 15, wherein the second portion of the roof layer extends parallel to a branch portion of the second first-pixel subpixel electrode.

18. The display device of claim 15, wherein the second portion of the roof layer is positioned between two pixel rows of the display device in a plan view of the display device.

19. The display device of claim 1,
wherein a first area of the display device corresponds to the first first-pixel subpixel electrode and has a first gray value,
wherein a second area of the display device corresponds to the second first-pixel subpixel electrode and has a second gray value,
wherein a third area of the display device corresponds to the first second-pixel subpixel electrode and has a third gray value,
wherein a fourth area of the display device corresponds to the second second-pixel subpixel electrode and has a fourth gray value, and
wherein the first gray value, the second gray value, the third gray value, and the fourth gray value are unequal to one another.

20. The display device of claim 1, wherein a dielectric anisotropy of the first liquid crystal material is different from a dielectric anisotropy of the second liquid crystal material.
